(19) United States
(12) Patent Application Publication
(10) Pub. No.: US 2026/0052148 A1
(43) Pub. Date: Feb. 19, 2026

(54) LIGHT CLIENTS FOR STATE TRANSITION PROOFS IN MULTI-BLOCKCHAIN ECOSYSTEMS

(71) Applicant: Ava Labs, Inc., New York, NY (US)

(72) Inventor: Patrick Robert O'Grady, Palo Alto, CA (US)

(21) Appl. No.: 19/285,235

(22) Filed: Jul. 30, 2025

Related U.S. Application Data
(60) Provisional application No. 63/684,681, filed on Aug. 19, 2024.

(51) Int. Cl. H04L 9/40

(52) U.S. Cl. CPC H04L 63/0884

(57) ABSTRACT

In some implementations, a method for processing state transition proofs in multi-blockchain ecosystems is provided. A registry blockchain network receives validator data that represents a validator set of a transaction blockchain network that is different from the registry blockchain network. The registry blockchain network stores the validator data on a registry blockchain, among validator data that represents other validator sets of other transaction blockchain networks. A registry client of the registry blockchain network receives a transaction identifier of a transaction that is purported to have been submitted by a transaction client to the transaction blockchain network, and evidence data of a committed state that indicates that the transaction has been included in a block that has been added to the transaction blockchain. The registry client independently verifies the evidence data of the committed state, based at least in part on the stored validator data.

### CROSS-REFERENCE TO RELATED APPLICATIONS

This application claims the benefit of priority of U.S. Provisional Ser. No. 63/684,681 , filed Aug. 19, 2024, the entirety of which is incorporated herein by reference.

### TECHNICAL FIELD

This specification generally relates to configuring light clients for processing state transition proofs in multi-blockchain ecosystems.

### BACKGROUND

Light clients can be deployed by blockchain users as an alternative to running full nodes. Full nodes operate by executing every transaction of a blockchain, and by storing the entire state of the blockchain, which can provide trustless access to the blockchain, but are generally resource-intensive operations. In contrast, light clients operate by downloading and verifying only the transaction data that is relevant to the client and/or by querying the value of a state—thus resulting in secure operations while conserving resources.

### SUMMARY

This document generally describes computer systems, processes, program products, and devices for processing state transition proofs (e.g., a proof that a blockchain transaction occurred, a proof that a smart contract was executed, etc.) in multi-blockchain ecosystems. In general, validator data that represents validator sets employed by various different transaction blockchains can be transmitted to a registry blockchain network and stored by a registry blockchain. In general, the registry blockchain can be a blockchain that is external to the transaction blockchains and that is configured to store the validator data that represents the validator sets of the transaction blockchains. Optionally, the registry blockchain can be part of an execution environment that performs operations in addition to the processing of state transition proofs. A negotiation can occur between a registry client (e.g., a light client) of the registry blockchain network and a transaction client (e.g., a client of one or more of the transaction blockchains), during which one of the transaction blockchains are selected for performing a blockchain transaction. The transaction client can submit a blockchain transaction to a blockchain network of the selected transaction blockchain, the transaction blockchain network can process the transaction, and the transaction client can provide a transaction identifier (e.g., a transaction hash) to the registry client. Additional evidence of the transaction having been performed (e.g., including a consensus signature of the transaction blockchain network and a transaction proof) can also be provided to the registry client. Upon receiving the transaction identifier and the transaction evidence, the registry client can independently verify whether the transaction actually occurred on the transaction blockchain, based on validator set data maintained by the registry blockchain, and based on an evaluation of the transaction evidence.

In a multi-blockchain ecosystem, users can have accounts on many different blockchain networks, and an entity (e.g., an individual, an organization, a business, etc.) is likely to want to support as many different blockchains as possible in order to facilitate transactions with other users. Data indexing providers can surface information about blockchain events through an application programming interface (API) that can be embedded into wallets and explorers, thus providing the ability to relate information about various different blockchains in a manner that is relatively lightweight for users of the API. However, the hosting of such APIs involves significant costs and processing resources to avoid downtime or hacks by external parties. Further, if a data indexing provider is compromised, incorrect information can be surfaced, and if the data indexing provider goes offline, there may be a delay until the provider is brought back online. By operating a registry client of a registry blockchain that tracks validator sets of various different transaction blockchains, the registry client can independently verify whether information surfaced by the data indexing provider is correct. Further, in examples in which the registry client is a light client, the information can be verified without employing the processing resources of a full node.

In some implementations, a method for processing state transition proofs in multi-blockchain ecosystems includes: receiving, by a registry blockchain network, validator data that represents a validator set of a transaction blockchain network that is different from the registry blockchain network, wherein the validator set includes validator nodes of the transaction blockchain network that are responsible for adding blocks to a transaction blockchain maintained by the transaction blockchain network; storing, by the registry blockchain network and on a registry blockchain maintained by the registry blockchain network, the validator data that represents the validator set of the transaction blockchain network, among validator data that represents other validator sets of other transaction blockchain networks; receiving, by a registry client of the registry blockchain network, (i) a transaction identifier of a transaction that is purported to have been submitted by a transaction client to the transaction blockchain network, and (ii) evidence data of a committed state that indicates that the transaction has been included in a block that has been added to the transaction blockchain by the validator nodes of the transaction blockchain network; independently verifying, by the registry client, the evidence data of the committed state that indicates that the transaction has been included in the block that has been added to the transaction blockchain by the validator nodes of the transaction blockchain network, based at least in part on the stored validator data that represents the validator set of the transaction blockchain network.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The registry client can be a light client of the registry blockchain network and not a client of the transaction blockchain network. The validator data can include, for each validator node in the validator set of the transaction blockchain, a corresponding public key of the validator node that is used for signing finalized blocks that are added to the transaction blockchain. The registry client can provide to the transaction client, a set of blockchain identifiers for transaction blockchain networks that are currently supported by the registry client. For each of the transaction blockchain networks that are currently supported by the registry client, respective validator data that represents the validator set of the transaction blockchain network can be stored by the registry blockchain network on the registry blockchain. The transaction can involve a transfer of blockchain tokens from a blockchain account that is associated with the transaction client to a blockchain account that is associated with the registry client. At least a portion of the evidence data can be received by the registry client from the transaction client. At least a portion of the evidence data can be received by the registry client from a data indexing provider. The evidence data can include at least a consensus signature for the block that has been added to the transaction blockchain by the validator nodes of the blockchain network, and a transaction proof that shows that the transaction is included in the block. Independently verifying the evidence data can include: accessing, by the registry client and from the registry blockchain, the stored validator data that represents the validator set of the transaction blockchain network; determining, by the registry client, that the consensus signature was generated by the validator set of the transaction blockchain network; and determining, by the registry client, that the transaction identifier of the transaction that is purported to have been submitted by the transaction client to the transaction blockchain network is represented in the transaction proof, and that the transaction proof is correct. The registry client can provide to a front-end application, an indication of whether the verifying was successful or unsuccessful.

The systems, devices, program products, and processes described throughout this document can, in some instances, provide one or more of the following advantages. A registry client can be a light client, which can conserve communication bandwidth and processing resources relative to that of a full node. A registry client can independently verify whether transaction evidence for a particular transaction indicates that the transaction was actually processed and included in a block of a transaction blockchain. An architecture for supporting multiple different transaction blockchains can be easily extendable, in that the registry client does not need to be a client of any of the transaction blockchains for which it is configured to verify transactions. Further, many possible block formats can be supported, and it is not a requirement for transaction blockchains to run the same virtual machine in order to be compatible with the registry client.

Other features, aspects and potential advantages will be apparent from the accompanying description and figures.

### DESCRIPTION OF DRAWINGS

FIG. 1 is a conceptual diagram of an example system for configuring light clients for processing state transition proofs in multi-blockchain ecosystems.

FIGS. 2A-2E depict an example illustrative system and process for configuring light clients for processing state transition proofs in multi-blockchain ecosystems.

FIG. 3 is a schematic diagram that shows an example of a computing system.

Like reference symbols in the various drawings indicate like elements.

### DETAILED DESCRIPTION

This document describes technology for processing state transition proofs in multi-blockchain ecosystems. In general, validator data that represents validator sets employed by various different transaction blockchains can be transmitted to a registry blockchain network and stored by a registry blockchain. One of the transaction blockchains can be selected for performing a blockchain transaction. The transaction client can submit a blockchain transaction to a blockchain network of the selected transaction blockchain, the transaction blockchain network can process the transaction, and the transaction client can provide a transaction identifier to the registry client. Additional evidence of the transaction having been performed can also be provided to the registry client. Upon receiving the transaction identifier and the transaction evidence, the registry client can independently verify whether the transaction actually occurred on the transaction blockchain, based on validator set data maintained by the registry blockchain, and based on an evaluation of the transaction evidence.

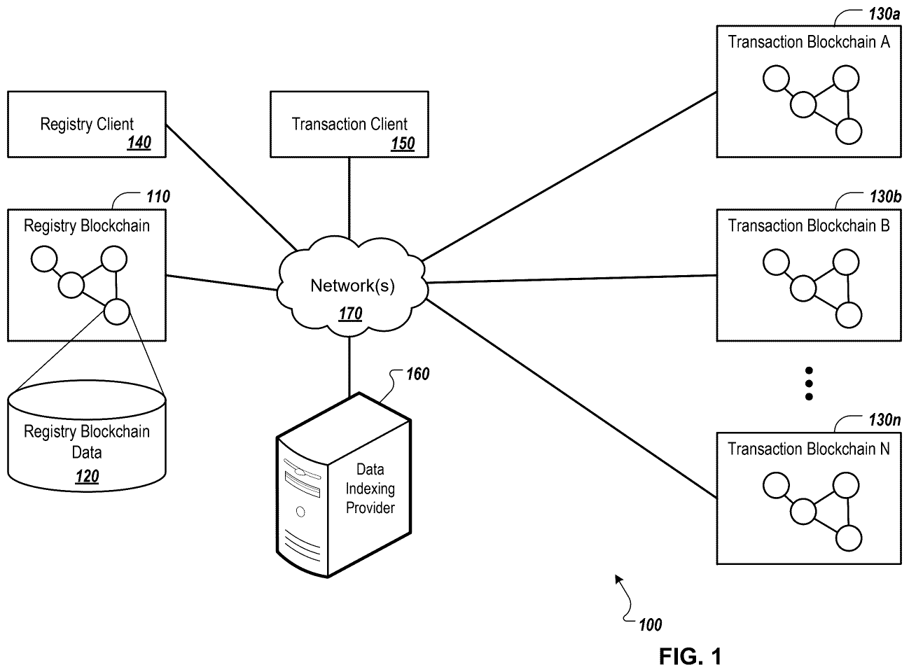

FIG. 1 is a conceptual diagram of an example system 100 for configuring light clients for processing state transition proofs in multi-blockchain ecosystems (e.g., processing proofs produced by nodes of a blockchain network that maintain a blockchain state). In general, the system 100 can include various computing devices, server systems, blockchain networks, and data stores, configured to communicate with each other over one or more communication networks. For example, the system 100 can include a registry blockchain 110, registry blockchain data 120, various transactions blockchains 130a-n, a registry client 140, a transaction client 150, and a data indexing provider 160, that can communicate and exchange data over networks(s) 170 (e.g., including one or more LANs (local area networks), WANs (wide area networks) and/or the Internet.

The registry blockchain 110, for example, can be a blockchain network including a plurality of computing nodes that are configured to communicate with and exchange data with each other (e.g., over the network(s) 170), with at least some of the computing nodes being validator nodes that are configured to maintain the blockchain 170 (e.g., through a consensus protocol). The computing nodes of the registry blockchain 110, for example, can each be various forms of servers, including but not limited to network servers, web servers, application servers, or other suitable computing servers. Each of the computing nodes can include one or more processors, memory devices, and storage devices. In some implementations, the computing nodes can be configured as a peer-to-peer network, in which nodes can be flexibly added to or removed from the network over time. Each of the computing nodes in the peer-to-peer blockchain network, for example, can directly communicate with other network nodes, and can participate in network functions, such as executing code (e.g., blockchain application software, smart contracts, etc.), broadcasting and validating blockchain transactions, generating new blocks of transactions, verifying generated blocks, and so forth.

The registry blockchain data 120 represents persistent data that is maintained by the computing nodes of the registry blockchain 110. In general, the registry blockchain data 120 can include a series of consecutively added and linked blocks, with each block including one or more transactions that occurred in the registry blockchain 110 over consecutive time windows of substantially similar durations (e.g., a fraction of a second, several seconds, or several minutes, depending on the type and configuration of the blockchain 110). In some implementations, multiple of the computing nodes of the registry blockchain 110 can maintain a separate copy (e.g., a full or partial copy) of the blockchain (e.g., using one or more databases, file systems, and/or cached data sources). Thus, decentralization, robustness, and persistence of the registry blockchain 110 can be ensured.

Similar to the registry blockchain 110, for example, each of the transaction blockchains 130a-n can be a blockchain network including a plurality of computing nodes that are configured to communicate with and exchange data with each other (e.g., over the network(s) 170). The respective computing nodes of the respective transaction blockchains 130a-n, for example, can each be various forms of servers, including but not limited to network servers, web servers, application servers, or other suitable computing servers, and can each include one or more processors, memory devices, and storage devices. In general, each of the transaction blockchains 130a-n can process transactions (e.g., involving a transfer of an amount of cryptocurrency from one blockchain account to another, involving a deployment of a smart contract, involving an execution of a smart contract, and/or another sort of blockchain transaction) that are submitted to one or more blockchain nodes. Blockchain network functions and protocols can generally vary between each of the transaction blockchains 130a-n.

The registry client 140, for example, can be a light client of the registry blockchain 110, and is generally not a full or light client of any of the transaction blockchains 130a-n (however in some examples it may be). In general, a light client can include software and/or hardware that is configured to run a light node of a blockchain. The light node, for example, can run on various forms of stationary or mobile computing devices including, but not limited to a computer server, a desktop computer, a laptop computer, a tablet computer, a personal digital assistant (PDA), a smartphone, or other processing devices. Instead of downloading and verifying every full block and state data of the registry blockchain 110, and storing an entire ledger copy (e.g., as would a full node of the blockchain), the registry client 140 can instead download and verify block headers, which include significantly less data the full blocks and state data. A block header can include transaction and state roots (e.g., Merkle trees, or other hash-based data structures that facilitate an efficient and secure verification of large data sets) that reference the root hash of the state of the registry blockchain 110, and the hashes of all transactions within a particular block. As the transaction and state roots are contained in the block header in a condensed but verifiable format, the registry client 140 can receive selected block data from the registry blockchain 110 (e.g., either through a direct connection or a remote procedure call (RPC)), and can independently verify transactions on the blockchain 110, thus conserving communication bandwidth and processing resources of a device running the light node.

The transaction client 150, for example, can be a client of one or more of the transaction blockchains 130a-n. In various examples, the transaction client 150 can include software and/or hardware that is configured to run a full node, a light node, a wallet, or another device/program/service that can submit transactions to one or more of the blockchains 130a-n (e.g., by signing the transactions with a stored private key that corresponds to a blockchain account). The transaction client 150, for example, can be executed by various forms of stationary or mobile computing devices including, but not limited to a computer server, a desktop computer, a laptop computer, a tablet computer, a personal digital assistant (PDA), a smartphone, or other processing devices. In the present example, the registry client 140 and the transaction client 150 are shown as being separate devices, however, in some implementations, operations of the registry client 140 and the transaction client 150 can be performed at a same device.

The data indexing provider 160, for example, can be configured to organize, structure, and format data stored on one or more of the transaction blockchains 130a-n. For example, the data indexing provider 160 can extract relevant information from blockchain data, create indexes for the data, and provide a query interface (e.g., an application programming interface (API)) that can be used by various platforms and clients (e.g., transaction client 150 and/or registry client 140) for requesting specific blockchain information. The data indexing provider 160, for example, can be implemented using various forms of servers, including but not limited to network servers, web servers, application servers, or other suitable computing servers, with the servers including one or more processors, memory devices, and storage devices.

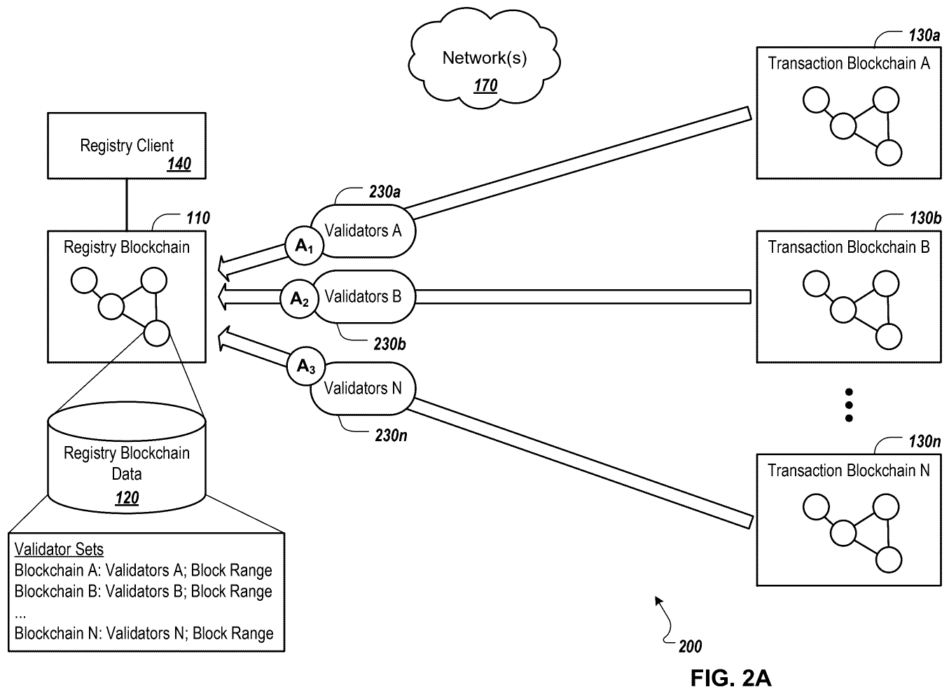

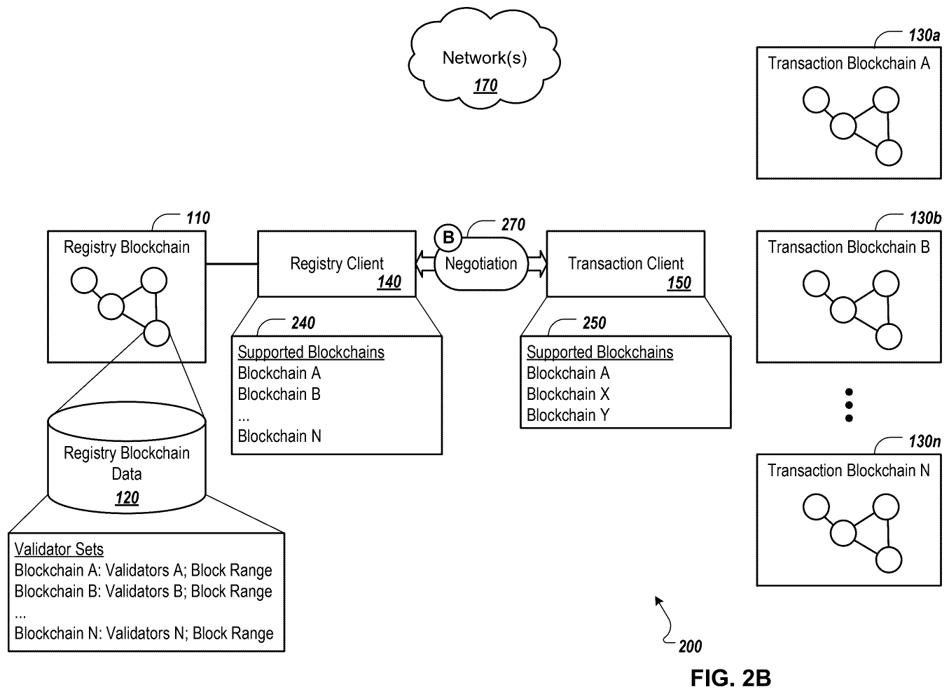

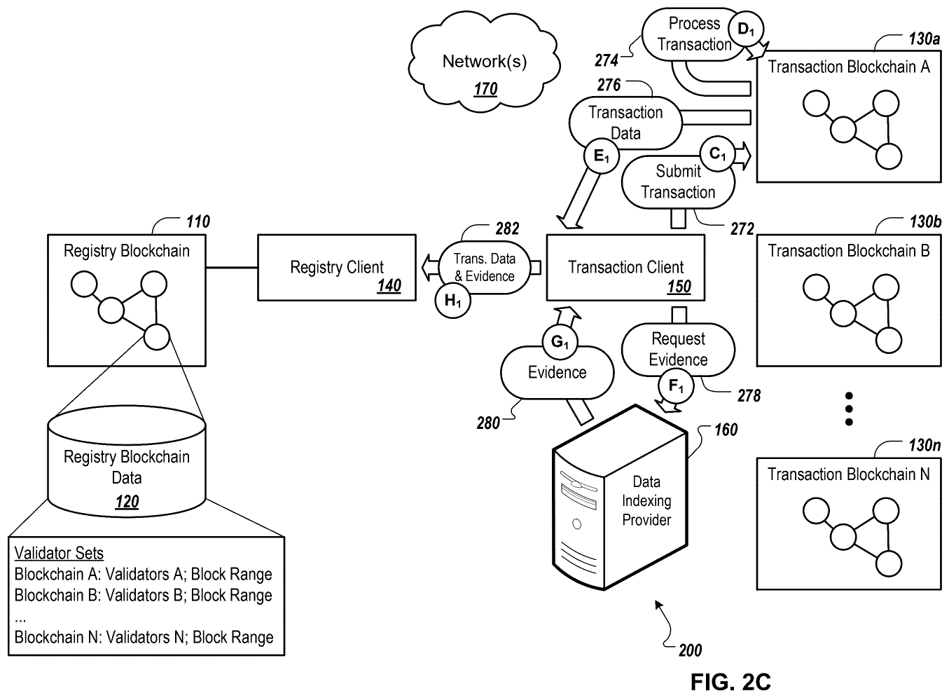

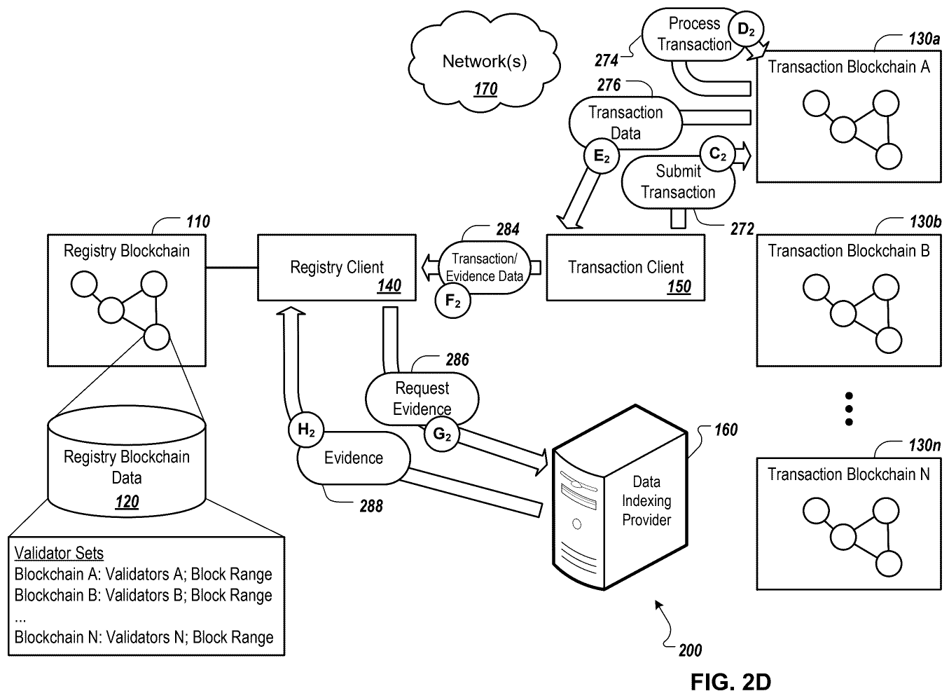

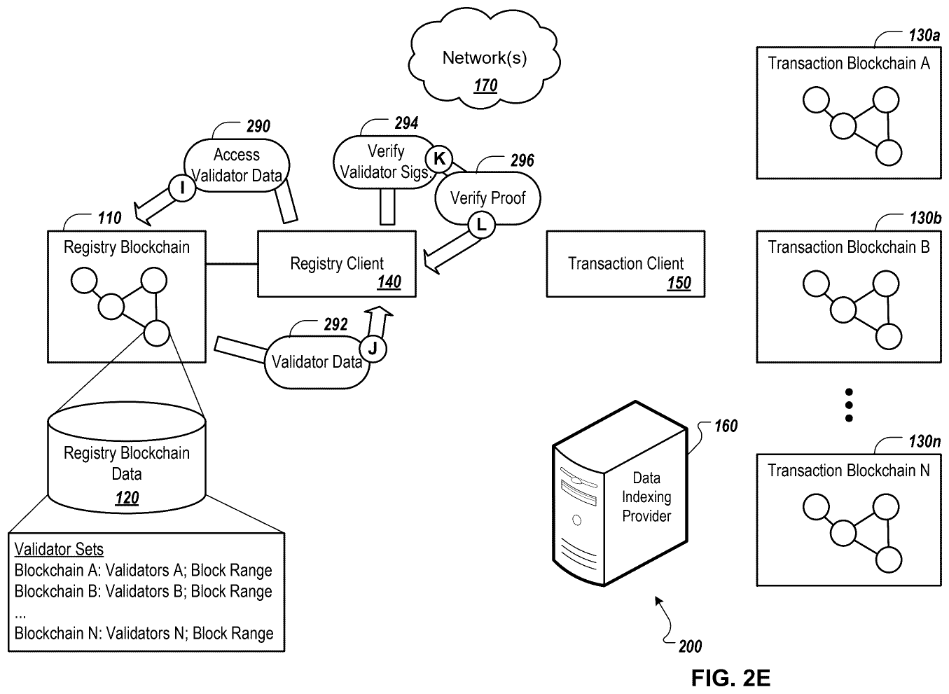

Referring now to FIGS. 2A-2E, an example illustrative system and process 200 are shown for configuring light clients for processing state transition proofs in multi-blockchain ecosystems, as represented in example stages (A) to (L). Stages (A) to (L) may occur in the illustrated sequence, or they may occur in a sequence that is different than in the illustrated sequence, and/or two or more stages (A) to (L) may be concurrent. In some examples, one or more stages (A) to (L) may be repeated multiple times when processing state transition proofs.

Referring to FIG. 2A, operations are shown for receiving and storing data related to validator sets for various transaction blockchains. In general, a validator set is a collection of computing nodes in a blockchain network that together verify transactions and perform consensus operations for adding new blocks to a blockchain.

A selection process for determining the validator nodes included in a validator set can vary, depending on the protocols of a particular blockchain network. For proof of stake (POS) blockchain networks, for example, blockchain nodes generally register with the blockchain network to be considered for selection as a validator node, and a validator set selection process is periodically performed by the by the nodes of the blockchain network (e.g., when a time interval has passed, when a number of blocks have been added to the blockchain, or based on another sort of selection process triggering criteria). The selection process can include evaluating a number of blockchain tokens staked by and/or delegated to candidate validator nodes, evaluating the past performance of the candidate validator nodes, randomized factors, or other suitable validator node selection factors. After a validator set has been selected the validator set can continue to work together, verifying blockchain transactions and performing consensus operations for adding new blocks to the blockchain, until such time that a new validator set is selected.

During stage (A), validator data that represents validator sets employed by various different transaction blockchains can be transmitted to a registry blockchain network and stored by a registry blockchain. For example, during stage (A₁), validator data 230a that represents a validator set currently being employed by the transaction blockchain 130a can be transmitted to a blockchain network of the registry blockchain 110 and stored by the blockchain. Similarly, during stages (A₂) and (A₃), validator data 230b and 230n that represents respective validator sets currently being employed by respective transaction blockchains 130b and 130n can be transmitted to the registry blockchain network and stored by the registry blockchain 110. The validator data 230a-n, for example, can include, for each validator node in each respective set of validators, one or more public keys corresponding to the validator node (with a public key corresponding to a private key used by the validator node for signing finalized blocks), and can optionally include other data that identifies the validator node. In some examples, validator data can also include a block height (or a range of block heights) at which the validator set is responsible for signing blocks. Upon receiving the validator data that represents the respective validator sets (e.g., validator data 230a, 230b, and 230n), the validator data can be stored by the registry blockchain 110 as registry blockchain data 120.

In some implementations, validator data can be transmitted by one or more nodes of a transaction blockchain, in response to the selection of a new validator set having been performed by a blockchain network. For example, blockchain networks for each of the respective transaction blockchains 130a-n can perform respective validator selections according to different, independent schedules. Immediately after having selected a new set of validators, for example, one or more nodes of the transaction blockchain 130a can submit a transaction to the registry blockchain 110 including the validator data 230a that indicates a new set of validators for a current epoch (a period of time during which the set of validator nodes that participate in consensus for the blockchain 130a are fixed). Similarly, one or more nodes of the transaction blockchains 130b and 130n can each submit respective transactions to the registry blockchain 110 including the respective validator data 230b and 230n, immediately after having selected new sets of validators.

In some implementations, validator data can be retrieved by one or more nodes of a registry blockchain. For example, one or more nodes of the registry blockchain 110 can continually monitor the transaction blockchains 130a-n for changes in validator sets being employed by the respective blockchains, and can retrieve and store the respective validator data 230a-n in response to detecting changes.

In some implementations, validator data can be maintained in association with a range of block heights. For each of the transaction blockchains 130a-n, for example, the registry blockchain data 120 can include data that represents a series of validator sets that have been employed by the transaction blockchain over time, and for each validator set, a range of block heights over which the validator set has been active. Thus, given a specified blockchain and a specified block height, the registry blockchain 110 can quickly determine a validator set that is/was responsible for confirming the block at that height.

Referring to FIG. 2B, operations are shown for negotiating a transaction blockchain on which a transaction is to be conducted between two or more entities (e.g., individuals, organizations, businesses, or other sorts of entities). In general, many thousands of different blockchains can exist, and a particular entity can chose to provide support for one or more of those blockchains. For each of the supported blockchains, for example, the entity can create and maintain a respective blockchain account (e.g., with corresponding private and public keys), which can be used to send and/or receive blockchain tokens, to interact with smart contracts on the blockchain, and so forth. Due to the vast and ever-changing number of different blockchains in use, it may not be practical to support all of the different blockchains, however by supporting a selected subset of the blockchains (e.g., including at least a portion of the most widely used blockchains), it is generally possible for two entities to identify a common blockchain on which each entity involved in a transaction has respective accounts.

During stage (B), the registry client 140 and the transaction client 150 can perform a negotiation protocol 270 for identifying and selecting a common blockchain for performing a transaction that involves accounts of the respective clients. In the present example, the registry client 140 can access and synchronize with the registry blockchain 110 (e.g., using a header synchronization approach, by leveraging a synchronization checkpoint, or using another lightweight technique for quickly synchronizing with the blockchain). Once synchronization has been performed, for example, the registry client 140 can access the registry blockchain data 120 of the registry blockchain 110 to determine identifiers for a set of blockchains 240 that are currently being supported by an entity that controls the registry client 140 (e.g., blockchains for which the entity has a blockchain account and for which the registry blockchain 110 has obtained current validator data). In the present example, the registry client 140 can support “Blockchain A,” “Blockchain B,” and “Blockchain N” (possibly among other blockchains). The transaction client 150 in the present example can also determine identifiers for a set of blockchains 250 that are supported by an entity that controls the transaction client 150 (e.g., blockchains for which the entity has a blockchain account). The entity that controls the registry client 140 can generally be different from the entity that controls the transaction client 150, however in some scenarios the entities can be the same entity.

In general, the negotiation protocol 270 for selecting a common blockchain for performing a transaction can include selecting a blockchain that is represented in both the set of blockchains 240 that are currently being supported through the registry client 140 and the set of blockchains 250 that are supported through the transaction client 150. For example, the registry client 140 can provide blockchain identifiers for its set of currently supported blockchains 240 to the transaction client 150, and the transaction client 150 can return a selected blockchain identifier (e.g., based on a selection by an operator of the transaction client 150, or based on an automatic and matching selection from the transaction client's set of supported blockchains 250 by the transaction client). As another example, the transaction client 150 can provide blockchain identifiers for its set of supported blockchains 250 to the registry client 140, and the registry client 140 can return a selected blockchain identifier (e.g., based on a selection by an operator of the registry client 140, or based on an automatic and matching selection from the registry client's set of currently supported blockchains 240 by the registry client).

In some implementations, a blockchain can be automatically selected from multiple commonly supported blockchains based at least in part on evaluating current transaction times and/or transaction costs for each of the commonly supported blockchains. For example, the registry client 140 and/or the transaction client 150 can determine current transaction times and/or transaction costs for each of the commonly supported blockchains (e.g., by querying a service that provides information about current blockchain conditions), and can select a blockchain having the shortest transaction times, the lowest transaction costs, or a weighted combination of advantageous transaction times and costs.

In some implementations, a negotiation protocol can be initiated by a front end application (not shown) that presents a list of identifiers of blockchains that are currently supported by a registry client. For example, the front end application can include a transaction portal (e.g., a portal for initiating blockchain token transfers, a portal for deploying and/or executing a smart contract, etc.), and can generate and present a list of blockchain identifiers that identifies at least some of the blockchains in the set of blockchains 240 that are currently supported by the registry client 140. An entity that controls the transaction client 150, for example, can then select a blockchain from the presented list.

In some implementations, a common blockchain can be selected and a transaction can be submitted on the selected blockchain before informing a registry client of the selection. For example, a blockchain can be manually or automatically selected from the set of blockchains 240 that are currently supported by the registry client 140 and that are also represented in the set blockchains 250 that are supported by the transaction client 150. After selecting one of the blockchains, for example, the transaction client 150 can proceed to submit a transaction on the selected blockchain before informing the registry client 140 of the selection.

Referring to FIG. 2C, operations can be performed for processing a transaction on a selected blockchain, and for providing evidence that the transaction has been processed to a registry client. A transaction, for example, can involve a transfer of blockchain tokens from one blockchain account to another (e.g., a transfer of blockchain tokens from a blockchain account that is associated with the transaction client 150 to a blockchain account that is associated with the registry client 140), a minting of a non-fungible token (NFT) (e.g., a minting of an NFT on one of the transaction blockchains 130 that is of interest to an entity that controls the registry client 140), and/or a deployment/execution of a blockchain smart contract (e.g., a deployment/execution of a smart contract that is of interest to an entity that controls the registry client 140). In the present example, the negotiation protocol 270 (shown in FIG. 2B) has resulted in the selection of transaction blockchain 130a (“Blockchain A”), and the transaction client 150 can proceed to submit the transaction to the transaction blockchain 130a. After the transaction has been submitted and processed, for example, evidence of the transaction can be provided to the registry client 140 for verification.

During stage (C₁), a command for performing a blockchain transaction can be submitted to a transaction blockchain, during stage (D₁), the transaction blockchain can process the transaction, and during stage (E₁), transaction data can be returned. For example, the transaction client 150 can submit a transaction 272 to the selected transaction blockchain 130a (e.g., by signing the transaction with a private key of an account that is associated with the transaction client 150 and that is maintained by the client 150). Upon receiving the submitted transaction 272, nodes of the transaction blockchain 130a can generate a processed transaction 274 by verifying the submitted transaction 272 (e.g., using a corresponding public key of the account that is associated with the transaction client 150 and that is maintained by the blockchain 130a), executing the transaction, and adding the transaction to the blockchain 130a. Adding the submitted transaction 272 to the blockchain 130a can be performed by validator nodes of a current validation set of the transaction blockchain 130a (e.g., a validator set that is represented in the registry blockchain data 120) by validating and finalize the block according to the blockchain's consensus protocol. When a block including the processed transaction 274 has been added to the transaction blockchain 130a, the transaction client 150 can receive and/or retrieve transaction data 276 that confirms that the transaction has been added. The transaction data 276 can include various sorts of data that pertain to the processed transaction 274, such as a transaction identifier (e.g., a transaction hash), a transaction timestamp, a transaction status, and so forth. In some examples, the transaction data 276 can include a block header of a block that includes the processed transaction 274, or the full block.

During stage (F₁), a request can be transmitted for evidence of a blockchain transaction having been processed and added to a transaction blockchain and/or for evidence of an arbitrary blockchain state. For example, the transaction client 150 can transmit a transaction evidence request 278 including a request for a consensus signature of the validator set that validated, finalized, and added the block to the transaction blockchain 130a that includes the processed transaction 274, and a request for a proof that the processed transaction 274 was actually included in the block. The consensus signature, for example, can be a multi-signature that is generated using the respective private keys of at least a threshold of the validator nodes in the validator set (e.g., with the threshold relating to a number of nodes, a staking weight of the nodes, or another threshold as determined by a consensus protocol of the transaction blockchain 130a). The transaction proof, for example, can include hash structure (e.g., a Merkle proof, or another suitable hashed structure) that shows that a particular transaction is included in a tree (e.g., a Merkle tree) whose root is included in the block header of the block that was added to the transaction blockchain 130a. In the present example, the transaction evidence request 278 (e.g., including at least the transaction identifier of the processed transaction 274) can be transmitted by the transaction client 150 to the data indexing provider 160 (e.g., using an application programming interface (API) of the provider 160). In other examples (e.g., for scenarios in which the transaction client 150 is a full node of the transaction blockchain 130a), the request 278 can be handled directly by the transaction client 150.

During stage (G₁), evidence can be provided of a transaction blockchain having processed a blockchain transaction, and having added the transaction to a block of the blockchain (and/or evidence of an arbitrary blockchain state). For example, the transaction client 150 can receive transaction evidence data 280 of a committed state including the consensus signatures of the validator set that validated, finalized, and added the block including the processed transaction 274, and proof that the transaction was added to the block. In the present example, the transaction evidence data 280 of the committed state can be received from the data indexing provider 160 (e.g., in response to the provider 160 receiving and handling the request 278). In other examples (e.g., for scenarios in which the transaction client 150 is a full node of the transaction blockchain 130a), the data 280 can be retrieved directly by the transaction client 150 from the transaction blockchain 130a.

During stage (H₁), evidence of a transaction blockchain having processed a blockchain transaction, and having added the transaction to a block of the blockchain (and optionally, other data related to the transaction) can be provided to a registry client. For example, the registry client 140 can receive from the transaction client 150 transaction evidence data 282 that includes the consensus signatures of the validator set that validated, finalized, and added the block including the processed transaction 274, proof that the transaction was added to the block, and optionally, other data related to the transaction (e.g., a transaction identifier, an identifier of a blockchain on which the transaction occurred, an identifier of a block height at which the transaction occurred, a block header for a block including the transaction, the full block, and/or other relevant data).

Referring to FIG. 2D, additional or alternate operations can be performed for processing a transaction on a selected blockchain, and for providing evidence that the transaction has been processed to a registry client. Similar to FIG. 2C, for example, the negotiation process 270 (shown in FIG. 2B) has resulted in the selection of transaction blockchain 130a (“Blockchain A”), and the transaction client 150 can proceed to submit the transaction to the transaction blockchain 130a. However, in the present example of FIG. 2D, rather than simply receiving evidence that a processed transaction has been added to a blockchain from a transaction client, at least some operations for collecting evidence of the transaction can be performed by the registry client 140 itself.

During stage (C₂), a command for performing a blockchain transaction can be submitted to a transaction blockchain, during stage (D₂), the transaction blockchain can process the transaction, and during stage (E₂), transaction data can be returned. In the present example, stages (C₂), (D₂), and (E₂) can be performed in a similar manner to the respective stages (C₁), (D₁), and (E₁) described with respect to FIG. 2C.

During stage (F2), transaction and/or evidence data of a committed state that is related to a processed blockchain transaction that has been submitted by a transaction client can be received by a registry client. For example, the registry client 140 can receive from the transaction client 150 transaction/evidence data 284 that relates to the processed transaction 274 that had been submitted to the transaction blockchain 130a. In general, the transaction/evidence data 284 can include some or all of the transaction evidence data 282 (described with respect to FIG. 2C). For scenarios in which transaction-related and evidence-related data is included in the transaction/evidence data 284, the registry client 140 can be configured to verify the evidence data. For scenarios in which only transaction-related data (e.g., at minimum, a transaction identifier of the processed transaction 274) is included in the transaction/evidence data 284, the registry client 140 can be configured to independently retrieve evidence data that indicates whether the transaction actually occurred, and to verify the retrieved evidence data.

During stage (G₂), a request can be transmitted for evidence of a blockchain transaction having been processed and added to a transaction blockchain and/or for evidence of an arbitrary blockchain state. For example, the registry client 140 can transmit a transaction evidence request 286 including a request for a consensus signature of the validator set that validated, finalized, and added the block to the transaction blockchain 130a that includes the processed transaction 274, and a request for a proof that the processed transaction 274 was actually included in the block. The consensus signature and transaction proof, for example, can be similar to the signature and proof described with respect to FIG. 2C. Similar to the transaction evidence request 278 (also described with respect to FIG. 2C) transmitted by the transaction client 150, for example, the transaction evidence request 286 can include at least the transaction identifier of the processed transaction 274, which can be acquired by the registry client 140 through the transaction/evidence data 284. In the present example, the transaction evidence request 286 can be transmitted by the registry client 150 to the data indexing provider 160 (e.g., using an application programming interface (API) provided by the provider 160).

During stage (H₂), evidence can be provided of a transaction blockchain having processed a blockchain transaction, and having added the transaction to a block of the blockchain (and/or evidence of an arbitrary blockchain state). For example, the registry client 140 can receive transaction evidence data 288 including the consensus signatures of the validator set that validated, finalized, and added the block including the processed transaction 274, and proof that the transaction was added to the block. In the present example, the transaction evidence data 288 can be received from the data indexing provider 160 (e.g., in response to the provider 160 receiving and handling the request 286).

In some implementations, the transaction evidence data 288 can additionally or alternately include other data related to the transaction (e.g., an identifier of a block height at which the transaction occurred, a block header for a block including the transaction, the full block, and/or other relevant data). For example, for scenarios in which the transaction/evidence data 284 includes consensus signatures of the validator set and proof that the transaction was added to the block, the transaction evidence request 286 can include a request for other block data, and can be submitted to the data indexing provider 160 of the transaction client, or a different data indexing provider. By requesting and analyzing transaction evidence data from multiple different data indexing providers (who can generally be considered as untrusted third parties), for example, checks can be put in place to thwart potential nefarious actions by a single data indexing provider (and/or by a particular transaction client).

Referring to FIG. 2E, operations can be performed for verifying whether a particular transaction actually occurred on a transaction blockchain, based on validator set data maintained by a registry blockchain, and based on transaction evidence data provided to and/or retrieved by a registry client. For example, the registry client 140 (e.g., a light client of the registry blockchain 110) can readily access registry blockchain data 120 that indicates a particular validator set of a particular blockchain network that added a block to a transaction blockchain at a particular block height. The registry client 140 can then independently verify whether the transaction evidence for a particular transaction (e.g., the transaction evidence including the consensus signature and the transaction proof that was provided to the registry client 140) indicates that the transaction was actually processed and included in the block of the transaction blockchain.

During stages (I) and (J), a registry client can access validator data that is maintained by a registry blockchain. For example, the registry client 140 can perform access operations 290 to identify validator data 292 that is being maintained as registry blockchain data 120 by the registry blockchain 110. The access operations 290, for example, can include querying the registry blockchain data 120 (e.g., using a blockchain identifier of a blockchain on which the processed transaction 274 was purported to have occurred and based on the transaction's purported block height). In the present example, the validator data 292 can include the public keys of the validator nodes of the blockchain network of the transaction blockchain 130a (“Blockchain A”) that were responsible for adding a block to the blockchain at the block height.

During stage (K), a registry client can verify a consensus signature of a validator set of a transaction blockchain network. For example, the registry client 140 can perform verification operations 294 to verify a consensus signature represented in the validator data 292. The consensus signature, for example, can be included in a signed block header of a block that is purported to have been signed by the validator nodes of the transaction blockchain 130a and that is purported to include the processed transaction 274 of the transaction client 150. To verify the consensus signature, for example, the registry client 140 can use the public keys of the validator set identified in the registry blockchain data 120 and public key cryptography techniques (e.g., a Boneh-Lynn-Schacham (BLS) cryptographic signature scheme, or another suitable technique) to verify whether the consensus signature that was provided to the registry client 140 was actually generated by the validator set.

During stage (L), a registry client can verify a transaction proof that indicates that a processed transaction was included in a block of a transaction blockchain. For example, the registry client 140 can perform verification operations 296 to verify a transaction proof represented in the validator data 292. In general, verifying the transaction proof can include the use of a standardized proof format that is employed by the registry client 140, the transaction client 150, and/or the data indexing provider 160. The transaction proof, for example, can include a Merkle proof, a Verkle proof, a SNARK/STARK proof, or another sort of proof that shows that the transaction identifier of the transaction that is purported to have been processed and added to the block was actually added to the block. To verify the transaction proof, for example, the registry client 140 can verify whether the transaction identifier that was provided by the transaction client 150 matches the transaction identifier represented in the transaction proof, and whether the transaction proof is correct.

After the registry client 140 has verified the consensus signature of the validator set of the transaction blockchain network (during stage (K)) and has verified the transaction proof that indicates that the processed transaction was included in the block of the transaction blockchain (during stage (L)), the registry client 140 can be assured of the queried state of the transaction blockchain being canonical, and one or more additional operations can optionally be performed. For example, for scenarios in which a token transfer has occurred from an account of the transaction client 150 to an account of the registry client 140, after verification has been performed, the registry client 140 can transmit an indication of whether the verification was successful or unsuccessful (e.g., to a front-end application of a transaction portal, or another sort of application that is external to the registry client 140). The front-end application, for example, can present the indication of success/failure to an operator of the front-end application, and in response to a successful verification, can initiate a transfer of goods (e.g., electronic, physical, etc.) between account owners.

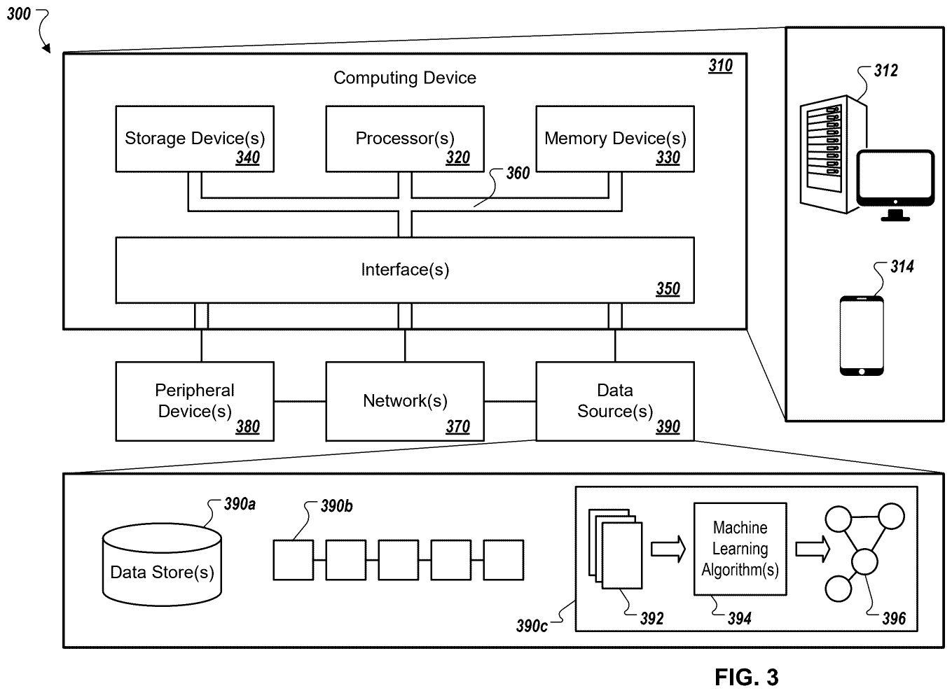

FIG. 3 is a schematic diagram that shows an example of a computing system 300 that can be used to implement the techniques described herein. The computing system 300 includes one or more computing devices (e.g., computing device 310), which can be in wired and/or wireless communication with various peripheral device(s) 380, data source(s) 390, and/or other computing devices (e.g., over network(s) 370). The computing device 310 can represent various forms of stationary computers 312 (e.g., workstations, kiosks, servers, mainframes, edge computing devices, quantum computers, etc.) and mobile computers 314 (e.g., laptops, tablets, mobile phones, personal digital assistants, wearable devices, etc.). In some implementations, the computing device 310 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 310, and an entire system can be made up of multiple devices communicating with each other. For example, the computing device 310 can be part of a computing system that includes a network of computing devices, such as a cloud-based computing system, a computing system in an internal network, or a computing system in another sort of shared network. Processors of the computing device (310) and other computing devices of a computing system can be optimized for different types of operations, secure computing tasks, etc. The components shown herein, and their functions, are meant to be examples, and are not meant to limit implementations of the technology described and/or claimed in this document.

The computing device 310 includes processor(s) 320, memory device(s) 330, storage device(s) 340, and interface(s) 350. Each of the processor(s) 320, the memory device(s) 330, the storage device(s) 340, and the interface(s) 350 are interconnected using a system bus 360. The processor(s) 320 are capable of processing instructions for execution within the computing device 310, and can include one or more single-threaded and/or multi-threaded processors. The processor(s) 320 are capable of processing instructions stored in the memory device(s) 330 and/or on the storage device(s) 340. The memory device(s) 330 can store data within the computing device 310, and can include one or more computer-readable media, volatile memory units, and/or non-volatile memory units. The storage device(s) 340 can provide mass storage for the computing device 310, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 350 can include various communications interfaces (e.g., USB, Near-Field Communication (NFC), Bluetooth, WiFi, Ethernet, wireless Ethernet, etc.) that can be coupled to the network(s) 370, peripheral device(s) 380, and/or data source(s) 390 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 350 can include a control interface that receives commands from an input device (e.g., operated by a user) and converts the commands for submission to the processors 320. The interface(s) 350 can include a display interface that includes circuitry for driving a display to present visual information to a user. The interface(s) 350 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 370 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 310 can communicate with the peripheral device(s) 380, the data source(s) 390, and/or other computing devices over the network(s) 370. In some implementations, the computing device 310 can directly communicate with the peripheral device(s) 380, the data source(s), and/or other computing devices.

The peripheral device(s) 380 can provide input/output operations for the computing device 310. Input devices (e.g., keyboards, pointing devices, touchscreens, microphones, cameras, scanners, sensors, etc.) can provide input to the computing device 310 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 310 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 390 can provide data for use by the computing device 310, and/or can maintain data that has been generated by the computing device 310 and/or other devices (e.g., data collected from sensor devices, data aggregated from various different data repositories, etc.). In some implementations, one or more data sources can be hosted by the computing device 310 (e.g., using the storage device(s) 340). In some implementations, one or more data sources can be hosted by a different computing device. Data can be provided by the data source(s) 390 in response to a request for data from the computing device 310 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 390a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 390b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 390c. The machine learning system(s) 390c, for example, can be used to analyze data from various sources (e.g., data provided by the computing device 310, data from the data store(s) 390a, data from the blockchain(s) 390b, and/or data from other data sources), to identify patterns in the data, and to draw inferences from the data patterns. In general, training data 392 can be provided to one or more machine learning algorithms 394, and the machine learning algorithm(s) can generate a machine learning model 396. Execution of the machine learning algorithm(s) can be performed by the computing device 310, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents the trustworthiness of evidence data provided by data indexing providers and/or transaction clients (e.g., by identifying instances in which provided evidence data was later proven to be unreliable). The machine learning model that results from the machine learning algorithm(s) can be used to identify data indexing providers and/or transaction clients that are expected to provide reliable evidence data. Use of the machine learning model can provide the benefit of improved transaction reliability.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data.

Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for processing state transition proofs in multi-blockchain ecosystems, comprising:
receiving, by a registry blockchain network, validator data that represents a validator set of a transaction blockchain network that is different from the registry blockchain network, wherein the validator set includes validator nodes of the transaction blockchain network that are responsible for adding blocks to a transaction blockchain maintained by the transaction blockchain network;
storing, by the registry blockchain network and on a registry blockchain maintained by the registry blockchain network, the validator data that represents the validator set of the transaction blockchain network, among validator data that represents other validator sets of other transaction blockchain networks;
receiving, by a registry client of the registry blockchain network, (i) a transaction identifier of a transaction that is purported to have been submitted by a transaction client to the transaction blockchain network, and (ii) evidence data of a committed state that indicates that the transaction has been included in a block that has been added to the transaction blockchain by the validator nodes of the transaction blockchain network; and
independently verifying, by the registry client, the evidence data of the committed state, based at least in part on the stored validator data that represents the validator set of the transaction blockchain network.

2. The method of claim 1, wherein the registry client is a light client of the registry blockchain network and is not a client of the transaction blockchain network.

3. The method of claim 1, wherein the validator data includes, for each validator node in the validator set of the transaction blockchain, a corresponding public key of the validator node that is used for signing finalized blocks that are added to the transaction blockchain.

4. The method of claim 1, further comprising:
providing, by the registry client and to the transaction client, a set of blockchain identifiers for transaction blockchain networks that are currently supported by the registry client, wherein for each of the transaction blockchain networks that are currently supported by the registry client, respective validator data that represents the validator set of the transaction blockchain network is being stored by the registry blockchain network on the registry blockchain.

5. The method of claim 1, wherein the transaction involves a transfer of blockchain tokens from a blockchain account that is associated with the transaction client to a blockchain account that is associated with the registry client.

6. The method of claim 1, wherein at least a portion of the evidence data is received by the registry client from the transaction client.

7. The method of claim 1, wherein at least a portion of the evidence data is received by the registry client from a data indexing provider.

8. The method of claim 1, wherein the evidence data includes at least (i) a consensus signature for the block that has been added to the transaction blockchain by the validator nodes of the blockchain network, and (ii) a transaction proof that shows that the transaction is included in the block.

9. The method of claim 8, wherein independently verifying the evidence data comprises:
accessing, by the registry client and from the registry blockchain, the stored validator data that represents the validator set of the transaction blockchain network;
determining, by the registry client, that the consensus signature was generated by the validator set of the transaction blockchain network; and
determining, by the registry client, that the transaction identifier of the transaction that is purported to have been submitted by the transaction client to the transaction blockchain network is represented in the transaction proof, and that the transaction proof is correct.

10. The method of claim 1, further comprising:
providing, by the registry client and to a front-end application, an indication of whether the verifying was successful or unsuccessful.

11. A computer system for processing state transition proofs in multi-blockchain ecosystems, comprising:
one or more data processing apparatuses of a registry blockchain network, the one or more data processing apparatuses comprising one or more processors, memory, and storage devices storing instructions that, when executed, cause the one or more processors to perform operations comprising:
receiving, by the registry blockchain network, validator data that represents a validator set of a transaction blockchain network that is different from the registry blockchain network, wherein the validator set includes validator nodes of the transaction blockchain network that are responsible for adding blocks to a transaction blockchain maintained by the transaction blockchain network;
storing, by the registry blockchain network and on a registry blockchain maintained by the registry blockchain network, the validator data that represents the validator set of the transaction blockchain network, among validator data that represents other validator sets of other transaction blockchain networks;
receiving, by a registry client of the registry blockchain network, (i) a transaction identifier of a transaction that is purported to have been submitted by a transaction client to the transaction blockchain network, and (ii) evidence data of a committed state that indicates that the transaction has been included in a block that has been added to the transaction blockchain by the validator nodes of the transaction blockchain network; and
independently verifying, by the registry client, the evidence data of the committed state, based at least in part on the stored validator data that represents the validator set of the transaction blockchain network.

12. The computer system of claim 11, wherein the registry client is a light client of the registry blockchain network and is not a client of the transaction blockchain network.

13. The computer system of claim 11, wherein the validator data includes, for each validator node in the validator set of the transaction blockchain, a corresponding public key of the validator node that is used for signing finalized blocks that are added to the transaction blockchain.

14. The computer system of claim 11, the operations further comprising:
providing, by the registry client and to the transaction client, a set of blockchain identifiers for transaction blockchain networks that are currently supported by the registry client, wherein for each of the transaction blockchain networks that are currently supported by the registry client, respective validator data that represents the validator set of the transaction blockchain network is being stored by the registry blockchain network on the registry blockchain.

15. The computer system of claim 11, wherein the transaction involves a transfer of blockchain tokens from a blockchain account that is associated with the transaction client to a blockchain account that is associated with the registry client.

16. The computer system of claim 11, wherein at least a portion of the evidence data is received by the registry client from the transaction client.

17. The computer system of claim 11, wherein at least a portion of the evidence data is received by the registry client from a data indexing provider.

18. The computer system of claim 11, wherein the evidence data includes at least (i) a consensus signature for the block that has been added to the transaction blockchain by the validator nodes of the blockchain network, and (ii) a transaction proof that shows that the transaction is included in the block.

19. The computer system of claim 18, wherein independently verifying the evidence data comprises:
accessing, by the registry client and from the registry blockchain, the stored validator data that represents the validator set of the transaction blockchain network;
determining, by the registry client, that the consensus signature was generated by the validator set of the transaction blockchain network; and
determining, by the registry client, that the transaction identifier of the transaction that is purported to have been submitted by the transaction client to the transaction blockchain network is represented in the transaction proof, and that the transaction proof is correct.

20. The computer system of claim 11, the operations further comprising:
providing, by the registry client and to a front-end application, an indication of whether the verifying was successful or unsuccessful.
